(19) United States
(12) Patent Application Publication
(10) Pub. No.: US 2025/0077756 A1
(43) Pub. Date: Mar. 6, 2025

(54) SEMICONDUCTOR DEVICE AND LAYOUT DESIGN METHOD THEREOF

(71) Applicant: SAMSUNG ELECTRONICS CO., LTD., Suwon-si (KR)

(72) Inventor: Jong-Hyeok Kim, Suwon-si (KR)

(21) Appl. No.: 18/624,673

(22) Filed: Apr. 2, 2024

(30) Foreign Application Priority Data
Aug. 29, 2023 (KR) 10-2023-0113628

(51) Int. Cl. G06F 30/392; G06F 30/398

(52) U.S. Cl. CPC G06F 30/392; G06F 30/398

(57) ABSTRACT

A semiconductor device according to an exemplary embodiment may include a first block that includes a first macro area where a plurality of first macros is positioned, a second block that includes a second macro area where a plurality of second macros is positioned, and a third block that includes a third macro area where a plurality of third macros is positioned, and the first macro area may be positioned adjacent to the second macro area and the third macro area in at least one direction of a first direction and a second direction perpendicular to the first direction.

### CROSS-REFERENCE TO RELATED APPLICATION

This application claims priority to and the benefit of Korean Patent Application No. 10-2023-0113628 filed in the Korean Intellectual Property Office on Aug. 29, 2023, the entire contents of which are incorporated herein by reference.

### TECHNICAL FIELD

The present disclosure relates to a semiconductor device and a layout design thereof.

### BACKGROUND

A semiconductor device includes various constituent elements, which are coupled to one another through routing structures on a plurality of layers. The semiconductor device receives power voltage for driving the constituent elements from the outside and transfers the power voltage to the constituent elements through the routing structures on each layer. Electronic design automation (EDA) tools for positioning and coupling various constituent elements of a semiconductor device such that the constituent elements can interact with one another may depend on a variety of factors for efficient power voltage transfer.

Floorplanning is allocating space for macros that should be disposed adjacent to one another in the layout design of a semiconductor device and is an important step in EDA. The positions of macros that are determined by floorplanning may have a significant effect on the subsequent steps in the EDA design flow.

### SUMMARY

The present disclosure provides a layout design method of floorplanning macros and bump cells in the center region of a semiconductor device.

Further, the present disclosure provides a layout design method of floorplanning constituent elements such that it is possible to efficiently transfer power voltage received from the outside.

Furthermore, the present disclosure provides a semiconductor device designed using the above-mentioned layout design methods.

In general, aspects of the subject matter described in this specification can be embodied in a semiconductor device including: a first block that includes a first macro area where a plurality of first macros is positioned, a second block that includes a second macro area where a plurality of second macros is positioned, and a third block that includes a third macro area where a plurality of third macros is positioned, and the first macro area may be positioned adjacent to the second macro area and the third macro area in at least one direction of a first direction and a second direction perpendicular to the first direction.

Another general aspect can be embodied in a layout design method of a semiconductor device, the method including determining at least one bump cell of a plurality of bump cells positioned in the center area of a semiconductor device including the center area and an outer area around the center area, as a macro bump cell for providing a macro power voltage, determining a safe area from the macro bump cell, obtaining coordinate information on the safe area, and disposing a macro based on the obtained coordinate information.

Another general aspect can be embodied in a semiconductor device including: a center area and an outer area around the center area, and may include a bump cell that is positioned in the center area and transfers a macro power voltage received from the outside, a first block that includes a first macro area where a plurality of first macros are positioned and which has a portion overlapping a safe area determined on the basis of the position of the bump cell, a second block that includes a second macro area where a plurality of second macros that receive the power voltage from the bump cell are positioned, and a third block that includes a third macro area where a plurality of third macros that receive the power voltage from the bump cell are positioned, and the first through third macro areas may possess certain symmetries. For example, the combination of the first macro area and the second macro area may be symmetric in a first direction, and the combination of the first and the third macro area may be symmetric in a second direction perpendicular to the first direction. The first macro area may be adjacent to the second and third macro areas in at least one direction of the first direction and the second direction.

### BRIEF DESCRIPTION OF THE DRAWINGS

FIG. 1 is a flow chart of a design and manufacturing method of semiconductor devices.

FIG. 2 depicts an example of a design system of semiconductor devices.

FIG. 3 depicts an example of a floorplan of bump cells of a semiconductor device.

FIG. 4 depicts a comparative example of a floorplan of macros of a semiconductor device.

FIG. 5 depicts a plurality of layers of a semiconductor device according to a comparative example.

FIG. 6 is a plan view of a comparative example of a semiconductor device in which bump cells are disposed.

FIG. 7 is a flow chart of an example of a macro floorplanning method.

FIG. 8 depicts an example of a floorplan of bump cells.

FIGS. 9A and 9B depict an example of a safe area.

FIG. 10 is a plan view of an example of a semiconductor device.

FIG. 11 depicts a plurality of layers of an example of a semiconductor device.

FIG. 12A is a plan view of an example of a semiconductor device.

FIG. 12B depicts an example of a macro area.

FIG. 13A is a plan view of an example of a semiconductor device.

FIG. 13B is a plan view of an example of a semiconductor device.

FIG. 14 is a plan view of an example of a semiconductor device.

FIG. 15 is a cross-sectional view of an example of a semiconductor package including a semiconductor device manufactured using the disclosed techniques.

Identical constituent elements in the drawings are denoted by the same reference symbols, and redundant descriptions of identical constituent elements will not be made.

Accordingly, the drawings and description are to be regarded as illustrative in nature and not restrictive. Like reference numerals designate like elements throughout the specification. In the flow charts described with reference to the drawings, the order of operations may be changed, and several operations may be combined, and an operation may be divided, and some operations may not be performed.

### DETAILED DESCRIPTION

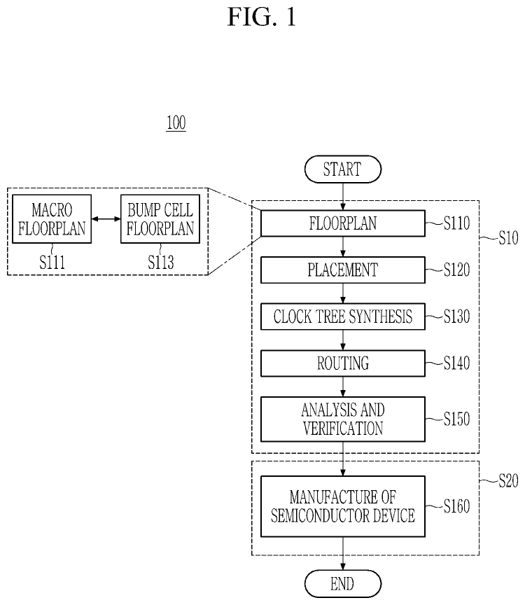

FIG. 1 is a flow chart of a design and manufacturing method of semiconductor devices.

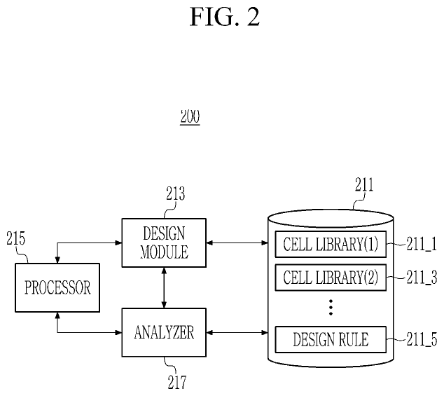

Referring to FIG. 1, a design and manufacturing method 100 of a semiconductor device includes a semiconductor device design step S10 and a semiconductor device manufacturing process step S20. The semiconductor device design step S10 is a step of designing a layout of circuits and may be performed in a design module for design and verification of integrated circuits. The design module for performing the semiconductor device design step S10 and a design system including the design module will be described below in more detail with reference to FIG. 2.

The semiconductor device manufacturing process step S20 is a step of manufacturing a semiconductor device based on the layout designed in the design system and may be performed in a semiconductor process module.

The semiconductor device design step S10 may include a floorplanning step S110, a placement step S120, a CTS (clock tree synthesis) step S130, a routing step S140, and an analysis and verification step S150. The semiconductor device may include a plurality of blocks depending on its functions. The semiconductor device design step S10 may be performed on a full-chip basis or on a block basis. In the following example, the semiconductor device design step S10 is performed on a block basis.

The floorplanning step S110 may be a step of creating a physical design by cutting out logically designed schematic circuits and moving them. The floorplanning step S110 may include a macro floorplanning step S111 and a bump cell floorplanning step S113.

The macro floorplanning step S111 may include a step of floorplanning macros that are included in each block in the semiconductor device. The macros may include memories such as SRAMs, ROMs, and the like, analog circuits such as analog-to-digital converters (ADCs) and the like, cores such as microcontroller units (MCUs), etc. The macro floorplanning step S111 may refer to disposing hard IPs (intellectual properties) such as memories, analog circuits, cores, etc. For example, macros required to be disposed adjacent to one another may be identified, and space may be allocated for the macros based on available space, required performance, and other factors.

The bump cell floorplanning step S113 may include a step of floorplanning bump cells in the semiconductor device. The bump cell floorplanning step S113 may include a step of disposing bump cells for providing a macro power voltage VDD_M and a ground voltage VSS to the macros of the semiconductor device and supplying a power voltage VDD and the ground voltage VSS to standard cells. The plurality of standard cells and the plurality of macros of the semiconductor device may consist of a plurality of transistors. The bump cells may be coupled to the plurality of transistors constituting the plurality of standard cells and the plurality of macros through a plurality of wiring lines. The bump cells may provide power voltage (VDD, VDD_M) received from the outside, e.g., from an external device, or the ground voltage VSS to the plurality of wiring lines to drive the transistors constituting the plurality of standard cells and the plurality of macros.

The standard cells and the macros may use different levels of power voltage. The power voltage VDD for operating the standard cells and the macro power voltage VDD_M for operating the macros may be different levels of voltage. Accordingly, power bump cells for providing the power voltage to the standard cells and macro bump cells for providing the power voltage to the macros may be distinguished.

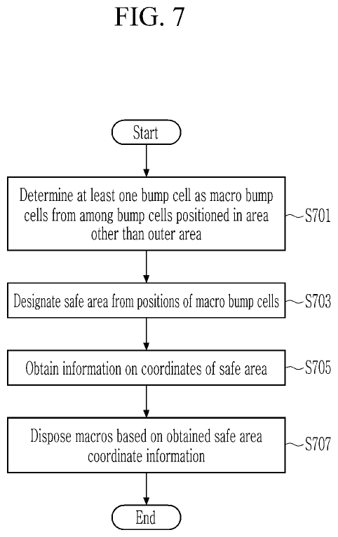

In some implementations, the macro bump cells for providing the macro power voltage VDD_M may be disposed based on the positions of the macros of the semiconductor device. In some implementations, the macros of the semiconductor device may be disposed based on the positions of the macro bump cells for providing the macro power voltage VDD_M. In some implementations, after the macro floorplanning step S111 is performed, the bump cell floorplanning step S113 may be performed. In some implementations, after the bump cell floorplanning step S113 is performed, the macro floorplanning step S111 may be performed. An example of a floorplanning step S110 will be described below with reference to FIG. 7 to FIG. 14.

The placement step S120 may include a step of disposing the standard cells. In the placement step S120, the standard cells may be disposed based on the interfaces between the constituent elements in the semiconductor device. In the placement step S120, the standard cells may be disposed based on the interfaces for the macros in the module. In some implementations, a design module disposes the macro.

The CTS step S130 may be a step of creating a clock distribution network to distribute a clock signal to sets of sequential circuit elements of the semiconductor device.

The routing step S140 may be a step of generating routing structures including a plurality of wiring lines and a plurality of vias to couple the standard cells and the macros disposed. The standard cells and the macros may be electrically coupled to one another through the routing structures or may be electrically coupled to the bump cells for providing the power or the ground voltage. The routing structures may be formed on a plurality of layers.

The analysis and verification step S150 may be a step of verifying and modifying the generated layout. STA (static timing analysis) for verifying whether the layout satisfies the timing condition of the design, DRC (design rule check) for verifying whether the layout has been correctly created to meet the design rules, ERC (electronical rule check) for verifying whether the layout has been correctly created without any internal electrical short, LSV (layout versus schematic) for verifying whether the layout matches the gate-level netlist, may be used to verify items.

The semiconductor device manufacturing process step S20 may include a semiconductor device manufacturing step S160.

The semiconductor device manufacturing step S160 may include a plurality of steps for manufacturing masks and forming a semiconductor package.

The semiconductor device manufacturing step S160 may include a step of generating mask data for forming various patterns on the plurality of layers by performing optical proximity correction (OPC) and the like on layout data generated in the semiconductor device design step S10, and a step of manufacturing masks using the mask data.

In the semiconductor device manufacturing step S160, various types of exposing and etching processes may be performed repeatedly. Through these processes, the forms of patterns configured during layout design may be sequentially formed on a silicon substrate.

Further, in the semiconductor device manufacturing step S160, a packaging process of mounting the semiconductor device on a PCB and encapsulating it with a molding material. Through the packaging process, the semiconductor device may be flipped or bonded onto the substrate using a plurality of contact members.

FIG. 2 depicts an example of a design system of semiconductor devices.

A design system 200 may include a storage device 211, a design module 213, a processor 215, and an analyzer 217. The design system 200 in FIG. 2 may perform at least some of the semiconductor device design operations designated in relation to the semiconductor device design step S10 in FIG. 1. The design system 200 may be implemented as an integrated device, and accordingly, may also be referred to as a design device. The design system 200 may be provided as a dedicated device for designing integrated circuits of semiconductor devices or a computer for driving various simulation tools or design tools.

The storage device 211 may contain first and second cell libraries 211_1 and 211_3 and design rules 211_5. The first and second cell libraries 211_1 and 211_3 and the design rules 211_5 may be provided from the storage device 211 to the design module 213 and the analyzer 217. The first and second cell libraries 211_1 and 211_3 may contain information on the heights and sizes of the standard cells, the macros, the bump cells, timings, and the like. The number of cell libraries that are included in the storage device 211 may vary.

The design module 213 may receive the cell libraries 211_1 and 211_3 from the storage device 211 for macro floorplanning, bump cell floorplanning, and the like in FIG. 1. The design module 213 may perform the placement step S120 of disposing the standard cells and the routing step S140 of coupling the disposed standard cells, the macros, and so on, shown in FIG. 1. Hereinafter, the term “module” may refer to software, hardware such as a field programmable gate array (FPGA) or an application specific integrated circuit (ASIC), or a combination of software and hardware. Further, the design module 213 may further include a component for performing the CTS step S130 in FIG. 1.

The processor 215 may be used by the design module 213 and the analyzer 217 to perform computations. For example, the processor 215 may include a microprocessor, an application processor (AP), a digital signal processor (DSP), a graphic processing unit (GPU), and so on. Although only one processor 215 is shown in FIG. 2, the design system 200 may include a plurality of processors. The processor 215 may include a cache memory for improving computing power.

The analyzer 217 may perform the analysis and verification step S150 in FIG. 1, and may analyze and verify the results of floorplanning, placement, and routing. The analyzer 217 may analyze and verify whether the macros and the bump cells floorplanned satisfy the predetermined design rules, e.g., based on the design rules 211_5 received from the storage device 211.

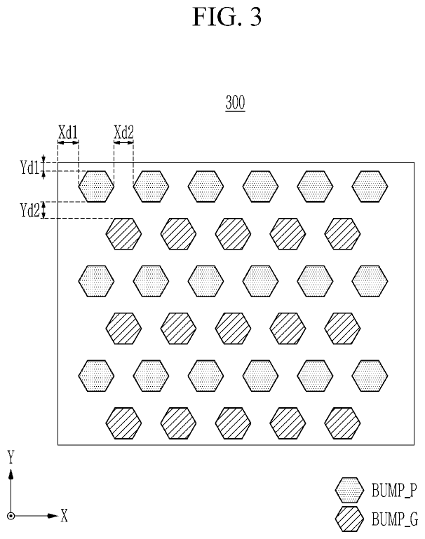

FIG. 3 depicts an example of a floorplan of bump cells of a semiconductor device.

Specifically, FIG. 3 shows a portion of a semiconductor device 300 obtained by performing the bump cell floorplanning step S113 according to a comparative example.

The semiconductor device 300 may include power bump cells BUMP_P and ground bump cells BUMP_G repeatedly disposed along a Y-axis. The power bump cells BUMP_P may receive the power voltage VDD from the outside, and the ground bump cells BUMP_G may receive the ground voltage VSS from the outside. In FIG. 3, it is shown that only power bump cells BUMP_P are disposed in the first row and only ground bump cells BUMP_G are disposed in the second row; however, the present disclosure is not limited thereto, and in one row, power bump cells BUMP_P and ground bump cells BUMP_G may be alternately disposed.

The power voltage VDD for operating the standard cells and the macro power voltage VDD_M for operating the macros may be different levels of voltage. Accordingly, at least the voltage levels distinguish the power bump cells BUMP_P for providing the power voltage to the standard cells from the macro bump cells for providing the power voltage to the macros. Some of the power bump cells BUMP_P or the ground bump cells BUMP_G may be replaced with macro bump cells for providing the macro power voltage VDD_M to the macros. Among the plurality of bump cells, bump cells to be replaced with macro bump cells may be determined based on the macro floorplan.

The power bump cells BUMP_P may provide the power voltage VDD received from the outside, to the standard cells in the semiconductor device 300, through a plurality of wiring lines. The macro bump cells may provide the macro power voltage VDD_M received from the outside, to the macros in the semiconductor device 300, through a plurality of wiring lines.

The size of the bump cells and the intervals between the bump cells may be determined in advance by the cell libraries (reference symbols “211_1” and “211_3” in FIG. 2) and the design rules (reference symbol “211_5” in FIG. 2). Specifically, the interval Xd1 from an edge of the semiconductor device 300 in a first direction (for example, an X direction) and the interval Yd1 from an edge of the semiconductor device 300 in a second direction (for example, a Y direction) may be determined in advance by the design rules 211_5.

Further, the interval Xd2 between the bump cells in the first direction (the X direction) and the interval Yd2 between the bump cells in the second direction (the Y direction) perpendicular to the first direction may be determined in advance by the design rules 211_5. Accordingly, the number and positions of bump cells that are included in the semiconductor device 300 may be determined in advance by the size of the semiconductor device 300.

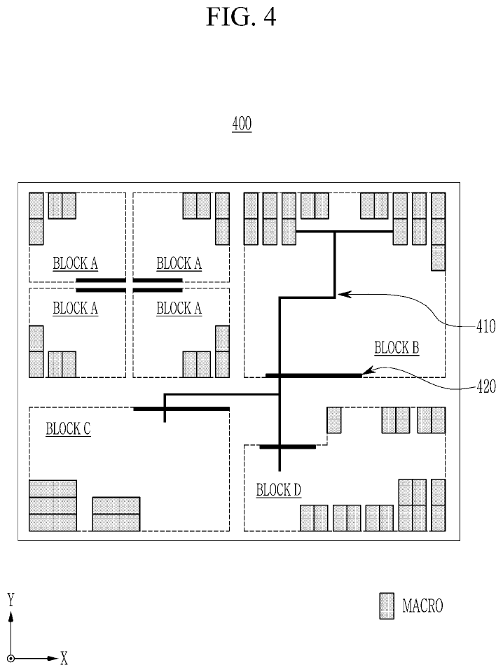

FIG. 4 depicts a comparative example of a floorplan of macros of a semiconductor device.

Specifically, FIG. 4 shows a portion of a semiconductor device 400 obtained by performing the macro floorplanning step S111 according to a comparative example.

The semiconductor device 400 may include a plurality of blocks, i.e., BLOCK A, BLOCK B, BLOCK C, and BLOCK D. The plurality of blocks, i.e., BLOCK A, BLOCK B, BLOCK C, and BLOCK D may be distinguished according to their functions. The plurality of blocks, i.e., BLOCK A, BLOCK B, BLOCK C, and BLOCK D may include different numbers and different types of standard cells and macros, respectively. The semiconductor device 400 may include multiple-instantiated modules (MIMs) or multiple-instantiated blocks (MIBs). In FIG. 4, BLOCK A may be a MIM. In FIG. 4, the number of types of blocks is four; however, the semiconductor device 400 may include more types of blocks.

The positions of the plurality of blocks, i.e., BLOCK A, BLOCK B, BLOCK C, and BLOCK D may be determined based on the interfaces between the blocks. The plurality of blocks, i.e., BLOCK A, BLOCK B, BLOCK C, and BLOCK D may include a plurality of pins 420 for the interfaces between the blocks. Standard cells and macros that are included in a first block (for example, BLOCK B) may be electrically coupled to standard cells and macros that are included in a second block (for example, BLOCK D) and a third block (for example, BLOCK C) different from the first block (BLOCK B), through the plurality of pins 420. The standard cells and the macros that are included in the first block (for example, BLOCK B) may be electrically coupled to the standard cells and the macros that are included in the second block (for example, BLOCK D) and the third block (for example, BLOCK C) different from the first block (BLOCK B), using a routing structure 410.

The plurality of blocks, i.e., BLOCK A, BLOCK B, BLOCK C, and BLOCK D may include different or identical macros, e.g., macros having the same size and type. The numbers and sizes of the macros that are included in the plurality of blocks, i.e., BLOCK A, BLOCK B, BLOCK C, and BLOCK D may be different from or equal to one another. The macros that are included in the plurality of blocks, i.e., BLOCK A, BLOCK B, BLOCK C, and BLOCK D may perform different functions. The plurality of macros in each of the blocks, i.e., BLOCK A, BLOCK B, BLOCK C, and BLOCK D may be disposed based on the interfaces between the blocks, i.e., BLOCK A, BLOCK B, BLOCK C, and BLOCK D, the interfaces between the macros, and the interfaces between the macros and the standard cells. The macros that are included in the semiconductor device 400 may be disposed so as not to interrupt with the interfaces in the blocks, i.e., BLOCK A, BLOCK B, BLOCK C, and BLOCK D or between the blocks, i.e., BLOCK A, BLOCK B, BLOCK C, and BLOCK D. The macros that are included in the semiconductor device 400 according to the comparative example may be disposed in the outer areas of the individual blocks including the macros, i.e., BLOCK A, BLOCK B, BLOCK C, and BLOCK D. The macros that are included in the semiconductor device 400 according to the comparative example may be disposed in the peripheral areas of the individual blocks including the macros, i.e., BLOCK A, BLOCK B, BLOCK C, and BLOCK D. The macros that are included in the semiconductor device 400 according to the comparative example may be disposed along the boundaries of the individual blocks including the macros, i.e., BLOCK A, BLOCK B, BLOCK C, and BLOCK D. In the individual blocks, i.e., BLOCK A, BLOCK B, BLOCK C, and BLOCK D, the plurality of standard cells may be disposed between the plurality of pins 420 and the macros.

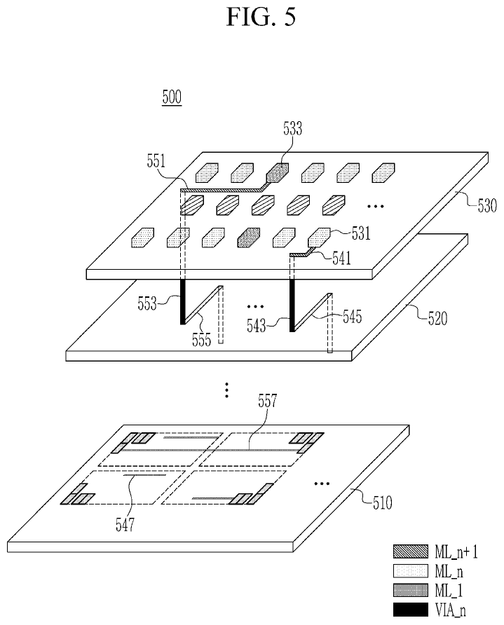

The layer where the bump cells in FIG. 3 are disposed and the layer where the macros in FIG. 4 are disposed may be different. This will be described in detail with reference to FIG. 5.

FIG. 5 depicts a comparative example of a plurality of layers of a semiconductor device.

A semiconductor device 500 may include a plurality of layers 510, 520, and 530. In FIG. 5, it is shown that the number of layers is three; however, the semiconductor device 500 may include four or more layers. In other words, the semiconductor device may further include a plurality of layers between the first layer 510 and the second layer 520 and may further include a lower layer below the first layer 510 and an upper layer on the third layer 530.

On the plurality of layers 510, 520, and 530, a plurality of metal lines may be positioned. The metal lines on each of the layers 510, 520, and 530 may be electrically coupled to the metal lines on the other layers through vias. Hereinafter, the layer 530 where bumps are disposed will be referred to as the bump layer, and the layer 510 where macros and standard cells are disposed will be referred to as the macro layer. Here, it is assumed that macros and standard cells are positioned on the same layer 510; however, the present disclosure is not limited thereto, and macros and standard cells may be positioned on different layers.

Referring to FIG. 5, the metal lines and the vias that are included in the individual layers 510, 520, and 530 are used to transfer the power voltages VDD_M and VDD and the ground voltage VSS from bump cells (for example, reference symbols “531” and “533”) on the bump layer 530 to macros and standard cells on the macro layer 510. Specifically, the first power bump cells 531 on the bump layer 530 may be electrically coupled to metal lines 541 (ML_n+1). The metal lines 541 (ML_n+1) may be electrically coupled to metal lines 545 (ML_n) on the second layer 520 through vias 543 (VIA_n). The first power bump cells 531 may be electrically coupled to the metal lines 545 (ML_n) on the second layer 520. The metal lines 545 (ML_n) on the second layer 520 may be coupled to metal line 547 (ML_1) on the first layer 510 through vias and metal lines existing between the second layer 520 and the first layer 510. In this way, the power voltage VDD that is provided from the first power bump cells 531 may be transferred to the individual standard cells on the macro layer 510 through the metal lines 547 (ML_1) on the macro layer 510. Further, first macro bump cells 533 on the bump layer 530 may be electrically coupled to the metal lines 541 (ML_n+1). Metal line 551 (ML_n+1) may be electrically coupled to metal lines 555 (ML_n) on the second layer 520 through vias 553 (VIA_n). Accordingly, the first macro bump cells 533 may be electrically coupled to the metal lines 555 (ML_n) on the second layer 520. The metal lines 555 (ML_n) on the second layer 520 may be coupled to metal lines 557 (ML_1) on the first layer 510 through vias and metal lines existing between the second layer 520 and the first layer 510. In this way, the macro power voltage VDD_M that is provided from the first macro bump cells 533 may be transferred to the individual macros on the macro layer 510 through the metal lines 557 (ML_1) on the macro layer 510. The metal lines and the vias that are included in the individual layers 510, 520, and 530 may be routing structures.

To facilitate the transfer of the power voltages to the individual macros and standard cells, the macro bump cells 533 and the power bump cells 531 may be disposed based on the positions of the macros and the standard cells. To minimize the lengths of the routing structures extending from the macro bump cells 533 to the macros and the routing structures extending from the power bump cells 531 to the standard cells, the macro bump cells 533 and the power bump cells 531 may be disposed based on the positions of the macros and the standard cells.

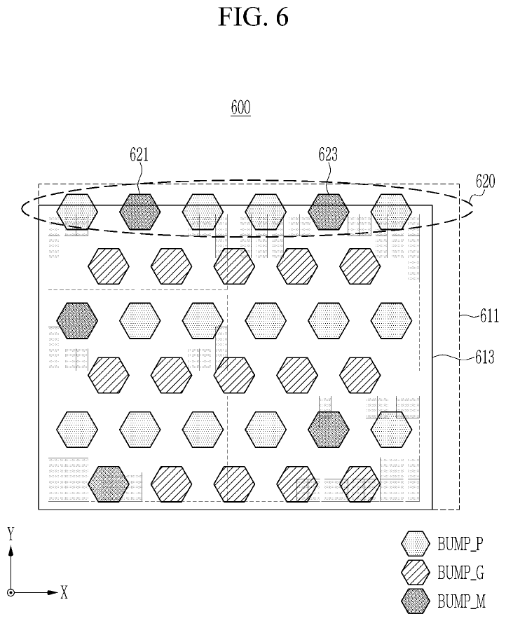

FIG. 6 depicts a comparative example of a semiconductor device in which bump cells are disposed.

As described above with reference to FIG. 4 and FIG. 5, a plurality of macros that is included in each block in a semiconductor device 600 may be disposed in the outer area of the corresponding block so as not to interfere with the interfaces in the corresponding block or between the blocks. Alternatively, the plurality of macros that is included in each block may be disposed along the boundary of the bock.

Most blocks in the semiconductor device 600 may be disposed along the boundary of the semiconductor device 600. Accordingly, at least some of the boundaries of the blocks in the semiconductor device 600 may be adjacent to the boundary of the semiconductor device 600. Alternatively, some of the plurality of macros that are included in the blocks in the semiconductor device 600 may be adjacent to the boundary of the semiconductor device 600.

Macro bump cells BUMP_M on a bump layer may be disposed based on the positions of macros on a macro layer. Accordingly, at least some of the macro bump cells BUMP_M may be positioned along the boundary of the semiconductor device 600. At least some of the macro bump cells BUMP_M may be positioned in the outer area of the semiconductor device 600. Bump cells positioned in the outer area of the semiconductor device 600 may refer to bump cells disposed the peripheral areas of the semiconductor device in a first direction X and a second direction Y.

During the design of the semiconductor device, the design conditions of the semiconductor device may be changed. The design conditions may include a change in the size of the semiconductor device. For example, if the size of the semiconductor device 600 is changed from a first size 611 to a second size 613, the bump cells disposed in an outer area 620 of the semiconductor device may be eliminated.

If the size of the semiconductor device 600 is changed, the plurality of macro bump cells BUMP_M (reference symbols “621” and “623”) disposed in the outer area 620 among the macro bump cells may be eliminated. If the macro bump cells BUMP_M (reference symbols “621” and “623”) are eliminated, it is required to add macro bump cells BUMP_M for the macros that are supposed to receive the macro power voltage VDD_M from the eliminated macro bump cells BUMP_M (reference symbols “621” and “623”). Accordingly, additional work is required to replace the bump cells disposed in the area adjacent to the area where the macro bump cells are disposed with macro bump cells BUMP_M. Disposition in the area adjacent to the area where the macro bump cells are disposed with macro bump cells BUMP_M increases repetitive work due to a change in a design condition and increasing the TAT (turn around time) due to the increase in repetitive work.

FIG. 7 is a flow chart of an example of a macro floorplanning method.

In some implementations, the bump cell floorplanning step (reference symbol “S113” in FIG. 1) may be performed, and the macro floorplanning step (reference symbol “S111” in FIG. 1) may be performed on the basis based on of the bump cells.

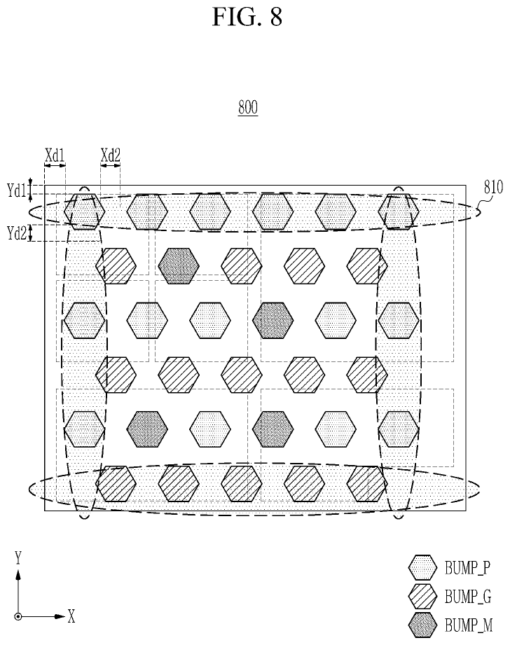

In this example, from among the plurality of bump cells in areas of the bump layer other than the outer area, at least one bump cell may be determined as macro bump cells (S701). STEP S701 will be described with reference to FIG. 8.

FIG. 8 depicts an example of a floorplan of bump cells.

As described in relation to the comparative example in FIG. 3, the sizes of the bump cells and the intervals Xd1, Xd2, Yd1, and Yd2 of the bump cells may be determined in advance by the cell libraries 211_1 and 211_3 and the design rules 211_5 and may be disposed by the number and positions of bump cells and the predetermined size of a semiconductor device 800.

In some implementations, the macro bump cells BUMP_M may be positioned in an area of the semiconductor device 800 other than an outer area 810. In some implementations, the area of the semiconductor device 800 other than the outer area 810 may refer to the center area. In some implementations, among the plurality of bump cells positioned in the area on the bump layer other than the outer area 810, i.e., the center area, at least one bump cell may be replaced with macro bump cells BUMP_M. In some implementations, the positions and number of macro bump cells BUMP_M may be disposed based on the positions and sizes of blocks in the semiconductor device 800 and the sizes and numbers of macros in the blocks.

In some implementations, the number of macro bump cells BUMP_M may satisfy a predetermined ratio to the number of power bump cells BUMP_P. The predetermined ratio may be determined in advance on the basis of the number of macros that are included in a semiconductor device.

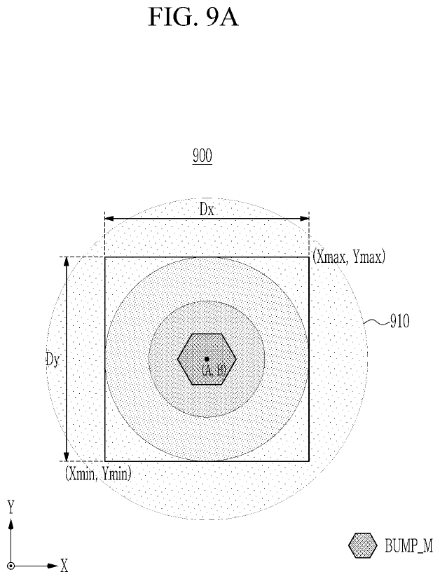

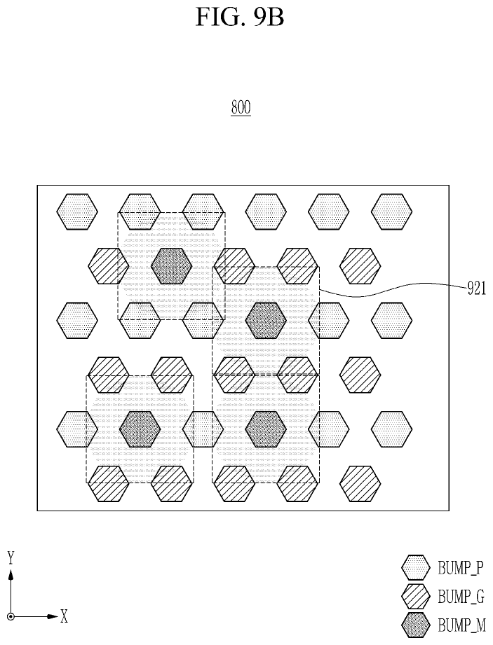

In some implementations, a safe area may be designated from the macro bump cells (S703). The safe area may refer to an area on the macro layer to which the macro power voltage VDD_M can be smoothly supplied from the macro bump cells BUMP_M. The safe area may refer to at least a portion of an area to which the macro power voltage VDD_M can be supplied from the macro bump cells BUMP_M. If the safe area is determined, it is possible to obtain information on the coordinates of the safe area from the positions of the macro bump cells (S705). Steps S700 and S705 will be described in more detail with reference to FIG. 9A and FIG. 9B.

FIG. 9A depicts an example of a safe area.

In some implementations, the macro power voltage VDD_M that is provided from the macro bump cells BUMP_M on the bump layer may be transferred to the macros through a plurality of routing structures on a plurality of layers between the bump layer and the macro layer.

As the distances from the macro bump cells BUMP_M increase, the lengths of the routing structures for transferring the macro power voltage VDD_M increase, and accordingly, the resistance of the routing structures may increase. Therefore, the strength of the macro power voltage VDD_M may decrease as the distances from the macro bump cells BUMP_M increase. For example, the strength of the macro power voltage VDD_M may be illustrated in a shape 910 spreading around a micro bump cell BUMP_M. FIG. 9A is an example for assisting in understanding, and actual macro power voltages may diffuse in other shapes.

In some implementations, a safe area 900 may be determined on the basis of the macro bump cells BUMP_M. In some implementations, the safe area 900 may be an area surrounding a macro bump cell BUMP_M by a predetermined size (reference symbols “Dx” and “Dy”). For example, the safe area 900 is a circle surrounding the coordinate (A,B), where the circle include a rectangle of maximum height Dx and maximum height Dy. Specifically, a simulation can provide output for a predetermined size that increases the likelihood that the macro bump cell BUMP_M will smoothly provide the macro power voltage VDD_M. Alternatively, the predetermined size may be size determined by a user in order for the macro bump cell BUMP_M to smoothly provide the macro power voltage VDD_M.

In some implementations, the coordinate information of the safe area 900 may be obtained based on the coordinate information (A, B) of the macro bump cell BUMP_M. In some implementations, if the predetermined size (reference symbols “Dx” and “Dy”) is determined, it is possible to obtain the minimum values (Xmin, Ymin) of the safe area 900 in a first direction X and a second direction Y and the maximum values (Xmax, Ymax) of the safe area in the first direction X and the second direction Y from the coordinate information (A, B) of the macro bump cell BUMP_M. For example, the minimum value Xmin in the first direction X and the minimum value Ymin in the second direction Y may be values obtained by subtracting the halves ((½)*Dx, (½)*Dy) of the sizes of the bump cell in the first direction X and the second direction Y from the coordinate information (A, B) of the macro bump cell, respectively. The maximum values (Xmax, Ymax) in the first direction X and the second direction Y may be values obtained by adding the halves ((½)*Dx, (½)*Dy) of the sizes of the bump cell in the first direction X and the second direction Y to the coordinate information (A, B) of the macro bump cell, respectively. FIG. 9B shows safe areas 921 marked on a semiconductor device 920. The safe areas 921 may be determined on a macro layer based on the positions of predetermined macro bump cells BUMP_M.

In some implementations, using the obtained safe area coordinate information, macros may be disposed (S707).

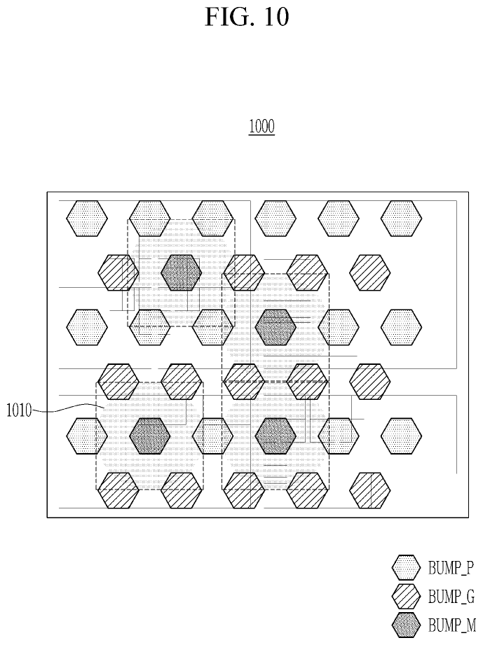

FIG. 10 is a plan view of an example of a semiconductor device. Specifically, semiconductor device 1000 may include macros disposed based on safe areas 1010 determined from the macro bump cells BUMP_M. In some implementations, the macros may be disposed based on the coordinate information on the safe areas 1010 determined based on the macro bump cells BUMP_M. However, at least some of the macros in each block may be positioned outside the safe areas 1010. For example, if the interfaces are between components or the number of macros exceeds the capacity of the corresponding safe area 1010, at least some of the macros in each block may be positioned outside the safe areas 1010.

In some implementations, the macros that are positioned outside the safe area 1010 may be disposed within a predetermined distance from the safe area 1010. The predetermined distance may be a value determined based on the lengths of routing lines by a user, such that the macro power voltage VDD_M is provided to every macro in the block. The user may determine a ratio through a simulation.

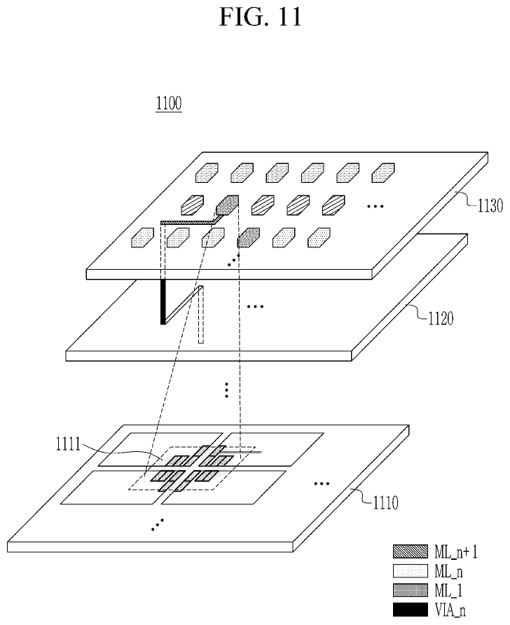

FIG. 11 depicts a plurality of layers of an example of a semiconductor device.

A semiconductor device 1100 may include a plurality of layers 1110, 1120, and 1130, and bump cells and macros may be positioned on different layers. For example, the bump cells may be positioned on the bump layer 1130, and the macros may be positioned on the macro layer 1110.

In some implementations, the macro power voltage VDD_M that is provided from the macro bump cells BUMP_M may be transferred to the macros through a plurality of routing structures ML_n+1, ML_n, ML_1, and VIA_n.

In some implementations, a safe area 1111 on the macro layer 1110 may be determined from the position of a macro bump cell BUMP_M on the bump layer 1130. The macros on the macro layer 1110 may be disposed based on the coordinate information on the safe area 1111.

The macro arrangement in this example can reduce the lengths of routing structures between the macro bump cell BUMP_M and the macros. The macro arrangement in this example can reduce a loss of the macro power voltage VDD_M that is provided from the macro bump cell BUMP_M.

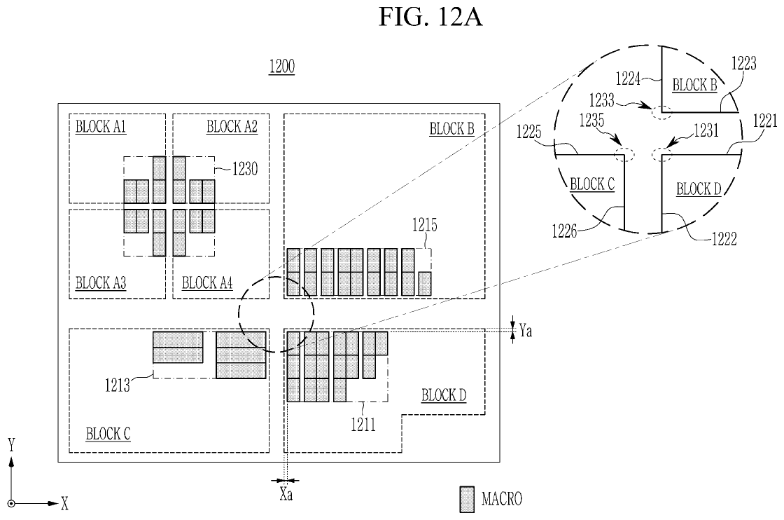

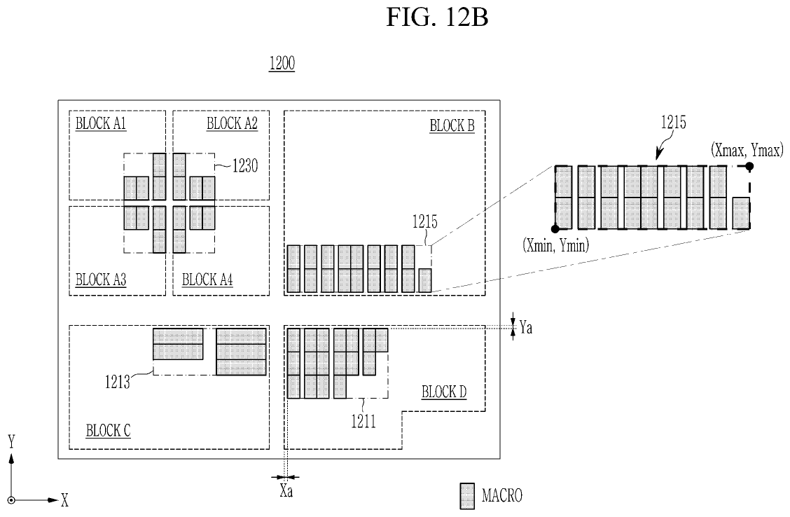

In another example, a macro floorplanning step (reference symbol “S111” in FIG. 1) may be performed, and a bump cell floorplanning step (reference symbol “S113” in FIG. 1) may be performed based on the positions of the macros. This will be described with reference to FIG. 12A and FIG. 12B to FIG. 14.

FIG. 12A is a plan view of an example of a semiconductor device.

In some implementations, a semiconductor device 1200 may include a plurality of blocks, i.e., BLOCK A, BLOCK B, BLOCK C, and BLOCK D, which are distinguished according to their functions. The plurality of blocks of the semiconductor device 1200, i.e., BLOCK A, BLOCK B, BLOCK C, and BLOCK D may be disposed adjacent to one another. In some implementations, when the plurality of blocks is referred to as being disposed adjacent to one another, the plurality of blocks may be disposed to have boundary surfaces at which they abut one another. In some implementations, the semiconductor device 1200 may include a first block (for example, BLOCK D) and a second block (for example, BLOCK C) adjacent to each other in a first direction (for example, an X direction), and the first block (for example, BLOCK D) and a third block (for example, BLOCK B) adjacent to each other in a second direction (for example, a Y direction) perpendicular to the first direction X.

In some implementations, the first block (BLOCK D) may include a first boundary surface 1221 extending in the first direction X, and a second boundary surface 1222 extending in the second direction Y. The first block (BLOCK D) may include a first intersection point 1231 where the first boundary surface 1221 and the second boundary surface 1222 meet. In some implementations, the first block (BLOCK D) may include a first macro area 1211 spaced apart from the first boundary surface 1221 and the second boundary surface 1222 by distances Xa and Ya according to the design rules 211_5. In some implementations, the distances Xa and Ya according to the design rules 211_5 may be different from or equal to each other. The macros in the first block (BLOCK D) may be formed in the first macro area 1211.

In some implementations, the second block (BLOCK C) adjacent to the first block (BLOCK D) in the first direction X may include a third boundary surface 1226 that is adjacent to the second boundary surface 1222 of the first block (BLOCK D) and extends in the second direction Y, and a fourth boundary surface 1225 that extends in the first direction X. The second block (BLOCK C) may include a second intersection point 1235 where the third boundary surface 1226 and the fourth boundary surface 1225 meet. In some implementations, the second intersection point 1235 may be an intersection point closest to the first intersection point 1231 among a plurality of intersection points included in the second block (BLOCK C). In some implementations, the second block (BLOCK C) may include a second macro area 1213 spaced apart from the third boundary surface 1226 and the fourth boundary surface 1225 by distances according to the design rules. The macros in the second block (BLOCK C) may be formed in the second macro area 1213. The second macro area 1213 may be adjacent to the first macro area 1211 in the first direction X.

In some implementations, the third block (BLOCK B) adjacent to the first block (BLOCK D) in the second direction Y may include a fifth boundary surface 1223 that is adjacent to the first boundary surface 1221 of the first block (BLOCK D) and extends in the first direction X, and a sixth boundary surface 1224 that extends in the second direction Y. The third block (BLOCK B) may include a third intersection point 1233 where the fifth boundary surface 1223 and the sixth boundary surface 1224 meet. In some implementations, the third intersection point 1233 may be an intersection point closest to the first intersection point 1231 among a plurality of intersection points included in the third block (BLOCK B). In some implementations, the third block (BLOCK B) may include a third macro area 1215 spaced apart from the fifth boundary surface 1223 and the sixth boundary surface 1224 by distances according to the design rules. The macros in the third block (BLOCK B) may be formed in the third macro area 1215. The third macro area 1215 may be adjacent to the first macro area 1211 in the second direction Y.

In some implementations, at least one the first block (BLOCK D), the second block (BLOCK C), and the third block (BLOCK B) may be disposed along the boundary surface of the semiconductor device 1200. In some implementations, the first macro area 1211, the second macro area 1213, and the third macro area 1215 may be disposed in the center area of the semiconductor device 1200.

In some implementations, the semiconductor device 1200 may include MIMs. In FIGS. 12A and 12B, BLOCK A (BLOCK A1, BLOCK A2, BLOCK A3, and BLOCK A4) may be a MIM. Neighboring blocks in BLOCK A may include boundary surfaces and intersection points as described above.

In some implementations, macros that are included in a first block (for example, BLOCK A1) and a second block (for example, BLOCK A2) may be symmetrical in the second direction Y, e.g., the shape including both BLOCK A1 and BLOCK A2 is symmetric along the second direction Y. In some implementations, macros that are included in the first block (BLOCK A1) and a third block (for example, BLOCK A3) may be symmetrical in the first direction X, e.g., the shape including both BLOCK A1 and BLOCK A3 is symmetric along the first direction X. In some implementations, a MIM may include macros disposed based on boundary surfaces adjacent to neighboring blocks. Macros in each of blocks of the MIM, i.e., BLOCK A1, BLOCK A2, BLOCK A3, and BLOCK A4 may form a macro area.

FIG. 12B is depicts an example of a macro area.

Referring to FIG. 12B, In some implementations, macros in each block may determine a macro area, and the coordinate information on the macro area may be obtained from the coordinate information on macros that are included in the macro area. For example, looking at a macro area 1215 of BLOCK B, the macro area 1215 may be disposed from a plurality of macros that is included in BLOCK B. Based on the coordinate information on each macro in BLOCK B, among the coordinate information on the corners of the corresponding macro, the minimum values (Xmin, Ymin) in the first direction X and the second direction Y and the maximum values (Xmax, Ymax) in the first direction X and the second direction Y may be obtained. The minimum values (Xmin, Ymin) in the first direction X and the second direction Y and the maximum values (Xmax, Ymax) in the first direction X and the second direction Y, obtained from the macro coordinate information, may be the minimum values (Xmin, Ymin) of the macro area 1215 in the first direction X and the second direction Y and the maximum values (Xmax, Ymax) of the macro area in the first direction X and the second direction Y.

In some implementations, the MIM may determine a macro area 1230 from the macros in the MIM. The entire MIM may form one macro area 1230.

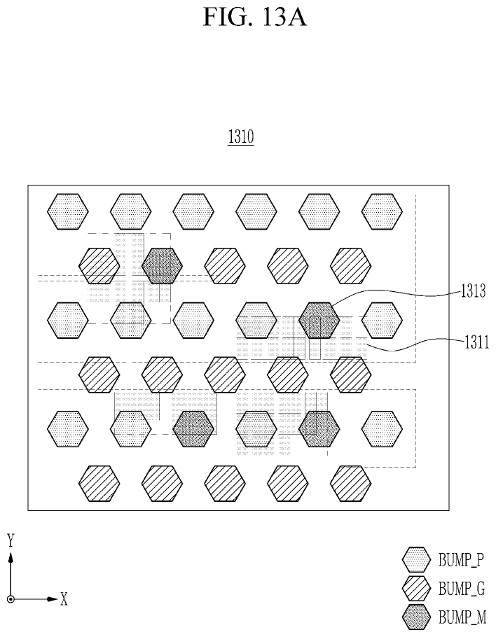

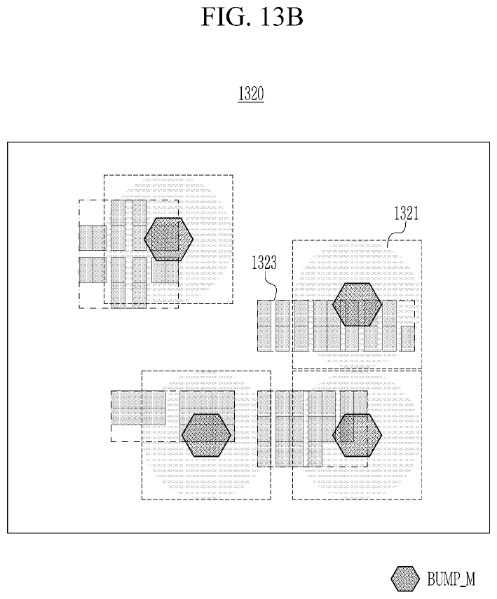

FIG. 13A and FIG. 13B are plan views of examples of semiconductor devices.

Specifically, FIG. 13A and FIG. 13B show macro bump cells BUMP_M disposed on the basis of the macro areas of individual blocks.

Referring to FIG. 13A, the positions of macro bump cells BUMP_M on a macro layer may be determined based on macro areas. For example, the position of a macro bump cell (BUMP_M) 1313 may be determined based on a macro area 1311. Bump cells on a bump layer positioned inside each macro area or an area adjacent to a macro area may be replaced with macro bump cells BUMP_M.

Referring to FIG. 13B, a safe area 1321 may be determined based on a macro bump cell BUMP_M through a simulation or by a user. The safe area 1321 can be substantially similar to safe area 900, and a detailed description of the safe area 1321 will not be repeated here.

In some implementations, the safe area 1321, which is determined by the macro bump cell BUMP_M and a macro area 1323 that is determined by a macro arrangement, may include an overlapping area. In some implementations, macro bump cells BUMP_M may be positioned inside the macro area 1323 determined by the macros or areas adjacent to the macro area 1323, whereby all or a portion of the macro area 1323 overlaps the safe area 1321 defined by the macro bump cell BUMP_M adjacent to the macro area. When a portion of the macro area 1323 overlaps the safe area 1321, the ratio of the size of the overlapping area to the size of the macro area 1323 may be equal to or greater than a predetermined ratio. The predetermined ratio may be a value determined by a user such that the macro power voltage VDD_M is stably provided to every macro in the block. The user may determine the predetermined ratio through a simulation.

In some implementations, a floorplan of macros and macro bump cells BUMP_M may reduce the lengths of routing structures between the macro bump cells BUMP_M and the macros, such that the macro power voltage VDD_M that is transferred from the macro bump cells BUMP_M can be smoothly supplied to the macros. In some implementations, a floorplan of macros and macro bump cells BUMP_M may reduce power issues such as voltage drops that may occur in the macros.

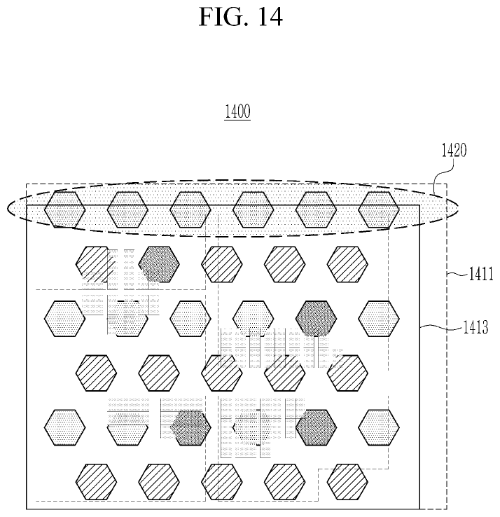

FIG. 14 is a plan view of an example of a semiconductor device. In this example, macro bump cells BUMP_M are disposed in areas of a semiconductor device 1400 other than the outer area.

In the semiconductor device design process, if the size of the semiconductor device 1400 is changed from a first size 1411 to a second size 1413, bump cells disposed in an outer area 1420 of the semiconductor device may be eliminated.

In some implementations, macro bump cells BUMP_M are disposed in an area of the semiconductor device 1400 other than the outer area, on the basis of the positions of macros. Accordingly, even when the size of the semiconductor device is changed, the macro bump cells BUMP_M may not be eliminated. This can solve the problem of increasing iterations based on changes in design conditions according to comparative examples and increasing TAT (turn around time) due to increased iterations.

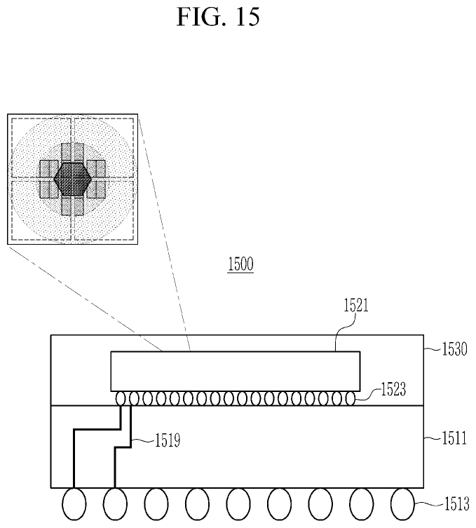

FIG. 15 is a cross-sectional view of an example of a semiconductor package including a semiconductor device.

Based on a layout designed In some implementations, a semiconductor device 1521 may be manufactured. By performing a packaging process of flipping or bonding the semiconductor device 1521 manufactured in a manufacturing module onto a substrate 1511, a semiconductor package 1500 may be manufactured.

The semiconductor package 1500 may include the semiconductor device 1521, the substrate 1511, coupling members 1523 coupled between the semiconductor device 1521 and the substrate 1511, external coupling members 1513 coupled to the substrate 1511, and a molding material 1530. FIG. 15 shows that the semiconductor device 1521 is mounted in a flip-chip bonding manner; however, the mounting method is not limited thereto. Further, although FIG. 15 depicts one semiconductor device 1521 mounted on the substrate 1511, a semiconductor die stack including a plurality of semiconductor devices may be mounted on the substrate 1511, and redistribution structures may be further included between the semiconductor device 1521 and the substrate 1511.

In some implementations, the semiconductor device 1521 includes macros for implementing blocks that perform various functions. In some implementations, the semiconductor device 1521 may include macros disposed.

The semiconductor device 1521 and wiring 1519 formed in the substrate 1511 may be electrically coupled together through the coupling members 1523 bonded onto the substrate 1511. In some implementations, the semiconductor device 1521 may receive the power voltages VDD and VDD_M and the ground voltage VSS from the outside through the coupling members 1523, the wiring 1519, and the external coupling members 1513. In some implementations, the coupling members 1523 may transfer the power voltages VDD and VDD_M and the ground voltage VSS to the semiconductor device 1521. In some implementations, bump cells laid out in a design system may be manufactured as the coupling members 1523 through a semiconductor device manufacturing process. The coupling members 1523 may include micro bumps.

In some implementations, macros that are included in the semiconductor device 1521 may be disposed based on the positions of the coupling members 1523 for providing the macro power voltage VDD_M. In some implementations, the coupling members 1523 for providing the macro power voltage VDD_M may be disposed on the basis of the positions of the macros that are included in the semiconductor device 1521.

The molding material 1530 may encapsulate the semiconductor device 1521 to protect the semiconductor device 1521 from external environments and secure electrical or mechanism stability of the semiconductor package 1500.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a combination can in some cases be excised from the combination, and the combination may be directed to a subcombination or variation of a subcombination.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A semiconductor device including a center area and an outer area around the center area, comprising:
a first block that includes a first macro area where a plurality of first macros is positioned;
a second block that includes a second macro area where a plurality of second macros is positioned;
a third block that includes a third macro area where a plurality of third macros is positioned; and
a plurality of bump cells positioned only in the center area and configured to provide a power voltage to the plurality of first macros, the plurality of second macros, and the plurality of third macros,
wherein the first macro area is positioned adjacent to the second macro area and the third macro area in at least one direction of a first direction and a second direction perpendicular to the first direction.

2. The semiconductor device of claim 1, wherein the first block includes a first boundary surface that extends in the first direction, a second boundary surface that extends in the second direction perpendicular to the first direction, and a first intersection point where the first boundary surface and the second boundary surface meet each other,
wherein the second block includes a third boundary surface that is adjacent to the first block, a fourth boundary surface that extends in a direction perpendicular to the direction in which the third boundary surface extends, and a second intersection point where the third boundary surface and the fourth boundary surface meet each other, and
wherein the third block includes a fifth boundary surface that is adjacent to the first block, a sixth boundary surface that extends in a direction perpendicular to the direction in which the fifth boundary surface extends, and a third intersection point where the fifth boundary surface and the sixth boundary surface meet each other.

3. The semiconductor device of claim 2, wherein the second block includes a plurality of first intersection points,
wherein the second intersection point is closest to the first intersection point among the plurality of first intersection points, and
wherein the third block includes a plurality of second intersection points, and the third intersection point is closest to the first intersection point among the plurality of second intersection points.

4. The semiconductor device of claim 2, wherein the first macro area is spaced apart from the first boundary surface by a first distance and is spaced apart from the second boundary surface by a second distance, and the first distance and the second distance are determined by a design rule.

5. The semiconductor device of claim 1, wherein the first macro area is determined based on coordinate information of a number of first macros in the first macro area.

6. The semiconductor device of claim 1, wherein a position of a first safe area is determined based on a position of a first bump cell among the plurality of bump cells, and the first safe area overlaps the first macro area.

7. The semiconductor device of claim 6, wherein the first safe area is an area surrounding the first bump cell by a predetermined size.

8. The semiconductor device of claim 6, wherein the first bump cell is configured to provide the power voltage to the plurality of first macros.

9. The semiconductor device of claim 8, wherein:
the first bump cell is electrically coupled to a first metal line on a first layer,
the plurality of first macros are electrically coupled to a second metal line on a second layer different from the first layer, and
wherein the first metal line and the second metal line are electrically coupled through at least one metal line on at least one layer positioned between the first layer and the second layer.

10. The semiconductor device of claim 1, wherein a combination of the second macro area and the first macro area is symmetric in a direction perpendicular to the direction in which the second macro area is adjacent to the first macro area, and
wherein a combination of the first macro area and the third macro area are symmetric in a direction in which the third macro area is adjacent to the first macro area.

11. A method of designing a layout of a semiconductor device, the method comprising:
determining at least one bump cell of a plurality of bump cells to be a macro bump cell configured to provide a macro power voltage, the at least one bump cell being positioned in a center area of a semiconductor device, the semiconductor device including the center area and an outer area around the center area;
determining a safe area of the macro bump cell;
obtaining coordinate information on the safe area; and
disposing a macro based on the obtained coordinate information.

12. The method according to claim 11, wherein the macro bump cell is electrically coupled to a first metal line on a first layer,
wherein the macro is electrically coupled to a second metal line on a second layer different from the first layer, and
wherein the first metal line and the second metal line are electrically coupled through at least one metal line on at least one layer positioned between the first layer and the second layer.

13. The method according to claim 11, wherein
the safe area is at least a portion of an area to which the macro power voltage is transferred, and
wherein determining the safe area includes determining a size of the safe area.

14. The method according to claim 13, wherein obtaining the coordinate information on the safe area comprises:
obtaining coordinate information on the macro bump cell; and
based on the coordinate information on the macro bump cell and the size of the safe area, obtaining a minimum value and a maximum value among coordinate values of the safe area in a first direction and obtaining a minimum value and a maximum value among the coordinate values of the safe area in a second direction perpendicular to the first direction.

15. The method according to claim 11, wherein a number of macro bump cells is determined based on a number of macros.

16. The method according to claim 11, wherein the macro forms a macro area, and the macro area overlaps the safe area.

17. A semiconductor device including a center area and an outer area around the center area, the semiconductor device comprising:
a bump cell that is positioned in the center area and is configured to transfer a macro power voltage received from an external device;
a first block that includes a first macro area where a plurality of first macros are positioned and, the first block having a portion overlapping a safe area determined based on position of the bump cell;
a second block that includes a second macro area where a plurality of second macros that are configured to receive the power voltage from the bump cell are positioned; and
a third block that includes a third macro area where a plurality of third macros that are configured to receive the power voltage from the bump cell are positioned,
wherein the first macro area and the second macro area are symmetric in a first direction, and the first macro area and the third macro area are symmetric in at least one of the first direction or a second direction perpendicular to the first direction, and
wherein the first macros area is adjacent to the second macro area and the third macro area in at least one direction of the first direction and the second direction.

18. The semiconductor device of claim 17, wherein a simulation determines the safe area, which is an area that increases a likelihood of the first macro area transferring the macro power voltage.

19. The semiconductor device of claim 17, wherein the plurality of first macros, the plurality of second macros, and the plurality of third macros include a same type of macro.

20. The semiconductor device of claim 19, further comprising a fourth block that includes a fourth macro area that is adjacent to the second macro area in a direction perpendicular to the direction in which the second macro area is adjacent to the first macro area,
wherein the fourth block is adjacent to the third macro area in a direction perpendicular to the direction in which the third macro area is adjacent to the first macro area, and
wherein a plurality of fourth macros that are included in the fourth macro area are identical to the plurality of first macros.
